(19) United States
(12) Patent Application Publication
(10) Pub. No.: US 2008/0150354 A1
(43) Pub. Date: Jun. 26, 2008

(54) Brake force generator for a vehicle hydraulic brake system and vehicle hydraulic brake system equipped therewith

(75) Inventors: Benedikt Ohlig, Vallendar (DE); Erwin Michels, Kail (DE)

Correspondence Address: MACMILLAN, SOBANSKI & TODD, LLC, ONE MARITIME PLAZA - FIFTH FLOOR, 720 WATER STREET, TOLEDO, OH, 43604, US

(73) Assignee: LUCAS AUTOMOTIVE GMBH

(21) Appl. No.: 12/002,864

(22) Filed: Dec. 19, 2007

(30) Foreign Application Priority Data
Dec. 22, 2006 (DE) 10 2006 061 022.9

(51) Int. Cl. B60T 13/60; B60T 13/68; B60T 8/32; F15B 13/044

(52) U.S. Cl. 303/152; 91/359

(57) ABSTRACT

The present invention relates to a brake force generator for a vehicle hydraulic brake system comprising a force input element that is connectable or connected to a brake pedal, a master cylinder, in which a primary piston is displaceably guided, wherein the primary piston with the master cylinder delimits a primary pressure chamber for generating a hydraulic brake pressure, and an actuating-force generating device for exerting an actuating force on the primary piston, wherein the actuating-force generating device comprises a control valve and a chamber arrangement, wherein the chamber arrangement is formed by a vacuum chamber and a working chamber, which is separated from the vacuum chamber by a movable wall and fluidically connectable by the control valve, and wherein the control valve comprises a control sleeve, which is displaceable relative to a valve element in accordance with a pedal actuation to achieve a pressure difference between the working chamber and the vacuum chamber that determines the actuating force. The invention provides that there is associated with the control valve a check sleeve, which is displaceable in accordance with specific operating conditions and the position of which may be used to influence the relative movement between control sleeve and valve element.

### CROSS-REFERENCE TO RELATED APPLICATIONS

This application claims priority to German Patent Application No. 10 2006 061 022.9 filed Dec. 22, 2006, the disclosure of which is incorporated herein by reference.

### BACKGROUND OF THE INVENTION

The present invention relates to a brake force generator for a vehicle hydraulic brake system which may include a force input element that is connectable or connected to a brake pedal, a master cylinder, in which a primary piston is displaceably guided, wherein the primary piston with the master cylinder delimits a primary pressure chamber for generating a hydraulic brake pressure, and an actuating-force generating device for exerting an actuating force on the primary piston, wherein the actuating-force generating device may include a control valve and a chamber arrangement, wherein the chamber arrangement is formed by a vacuum chamber and a working chamber, which is separated from the vacuum chamber by a movable wall and fluidically connectable by the control valve, and wherein the control valve comprises a control sleeve, which is displaceable relative to a valve element in accordance with a pedal actuation in order to achieve a pressure difference between the working chamber and the vacuum chamber that determines the actuating force. The present invention further relates to a vehicle brake system constructed with such a brake force generator.

In currently conventional brake systems, the hydraulic brake pressure needed to act upon the wheel brake of the vehicle is mostly generated by means of a master cylinder. For this purpose, it is necessary to introduce an actuating force on the said master cylinder, which actuating force is generally generated in response to an actuation of the brake pedal by the vehicle driver. For improved actuating comfort, the actual brake pedal force is conventionally increased by a predetermined percentage by means of a brake booster, thereby allowing the brake pedal actuating forces needed for a desired vehicle deceleration to be kept low in a way that enables each driver effortlessly to effect adequate braking of the vehicle. Such a brake system with a brake booster is known for example from the document DE 44 05 092 A1, and corresponding U.S. Pat. No. 5,493,946, both of which are incorporated by reference herein.

Furthermore, in modern brake systems the direct influence that the driver by means of his actuating action on the brake pedal exerts on the wheel brakes has meanwhile been limited or entirely eliminated. Instead, by decoupling the brake pedal from the brake system and by “synthetic” generation of an actuating force upon the primary piston in accordance with a pedal actuation or other parameters, an endeavour is made to provide a safer and more purposeful braking performance than is achievable through direct use of the brake pedal actuation. Such a brake system is described for example in the document DE 10 2004 041 924 A1, and corresponding U.S. patent number 2006/043788 A1, both of which are incorporated by reference herein.

The latest developments regarding the use of hybrid vehicles also have to be taken into account when developing brake systems. For instance, the batteries provided in hybrid vehicles have to be regularly charged in order to be able to provide enough electrical energy to operate the electric motor. Such charging operations are preferably to be effected by utilizing released kinetic energy of the vehicle. In this connection a term that is also used is regenerative braking. When the hybrid vehicle is braked, the electric motor of the hybrid vehicle may then be used as a generator. The kinetic energy is therefore converted by the electric motor acting as a generator into electrical energy and stored in the batteries. In order not to impair such regenerative braking, an endeavour is made to keep the conventional wheel brake system of the vehicle inactive for as long as possible in order to utilize the kinetic energy as extensively as possible for conversion into electrical energy by means of the electric motor acting as a generator. If however the deceleration brought about by the generator is no longer sufficient in the context of a braking operation, it is then necessary to bring the conventional brake system additionally into operation as quickly and steplessly as possible. For this purpose too, the previously mentioned document DE 10 2004 041 924 A1 as well as the background art according to DE 10 2004 012 260 B3 offer practicable, albeit technically relatively complex solutions.

### BRIEF SUMMARY OF THE INVENTION

One aspect of the present invention is to provide a brake force generator of the initially described type and a brake system constructed therewith, with which regenerative braking is made possible by relatively simple constructional and cost-effective means.

This aspect may be achieved by means of a brake force generator of the initially described type, in which there is associated with the control valve a check sleeve, which is displaceable in accordance with specific operating conditions and the position of which may be used to influence the relative movement between control sleeve and valve element.

In addition to the, as such, conventionally designed control valve the invention may provide the use of a separately displaceable check sleeve, by means of which influence may be brought to bear on the behaviour of the control valve.

Depending on the operating situation, it is therefore possible to allow the control valve to operate in a conventional manner so that a brake pedal actuation leads to the build-up of a pressure difference at the movable wall that may then be utilized to generate an actuating force upon the primary piston.

A further operating condition may moreover provide that the brake force generator according to the invention generates a brake force fully automatically without the brake pedal being actuated. This may be necessary for example if a vehicle assist system, such as for example adaptive cruise control, detects a need for a braking operation even though the driver has not actuated the brake pedal. In such a case too, a braking operation may be initiated by means of the check sleeve independently of the driver.

The check sleeve may moreover be used in such a way that it assists a driver during braking. Such assistance measures may be necessary for example in an emergency braking situation, in which a panic-like behaviour of the driver may result in incorrect actuation of the brake pedal and possibly lead to an accident. By suitable actuation of the check sleeve, incorrect behaviour of the driver in the emergency braking situation may be compensated.

Finally, the use according to one aspect of the invention of the check sleeve also allows a response of the brake force generator for generating an actuating force to be prevented despite actuation of the brake pedal for as long as, for example, the braking effect of a motor acting as a generator of a hybrid vehicle is sufficient to achieve the desired deceleration of a vehicle. Thus, by means of the invention it is also possible to realize regenerative braking in a highly efficient manner with maximum utilization of the kinetic energy released in the course of the deceleration. What is more, if the deceleration effect of the electric motor acting as a generator is no longer sufficient to fulfil the deceleration request expressed by the driver via the pedal actuation, the invention then allows the conventional brake system to come steplessly into operation in addition to the regenerative braking. The driver therefore may not notice any difference from conventional brake systems without a regenerative braking facility because in the case of the invention, upon activation of the conventional wheel brake system in addition to or instead of the regenerative braking, no abrupt increase of the deceleration occurs.

A development of the invention provides that the check sleeve may be displaceable electromagnetically. In this case, it may be provided that the check sleeve takes the form of an electromagnetic armature. It is therefore possible to control the electromagnetically displaceable check sleeve precisely and achieve a stepless actuation.

In a constructional variant of the invention it may be provided that the check sleeve is biased into a normal position by means of a spring arrangement and is displaceable in mutually opposite directions with simultaneous deflection of the spring arrangement. In this constructional variant of the invention, the check sleeve is actuable in two directions. In the first actuating direction, the check sleeve ensures a demand-related activation of the conventional brake system. A displacement of the check sleeve in the opposite, second actuating direction however tendentially counteracts an activation of the conventional brake system. Preferably, in the spring arrangement two springs are provided, which are effective in mutually opposite directions and the spring forces of which counterbalance one another in the normal position. Every deflection in one of the two actuating directions leads for example to a relaxation of the one spring and a compression of the other.

In order to achieve a space-saving and compact arrangement, a development of the invention provides that the check sleeve may surround the control sleeve in radial direction. Preferably, the check sleeve is provided with radial through-holes so as not to impede a fluidic connection between working chamber and pressure source, where required.

In order to achieve a simple structural design, a development of the invention provides that the control sleeve is connectable or connected mechanically to the force input element. In this way, the control sleeve may be actuated in a conventional manner via the force input element and in accordance with a brake pedal actuation a pressure difference may be built up at the movable wall, provided that the actually selected position of the check sleeve allows this. Alternatively, however, in addition to the electromagnetic actuation of the check sleeve an electromagnetic actuation of the control sleeve may be effected, for example by means of a second electromagnetic actuating mechanism, which in the normal operating situation is mechanically fully uncoupled from the brake pedal.

In a preferred constructional variant of the invention it is provided that the valve element is spring-biased in the direction of, and bringable into mutual abutment with, the control sleeve and the check sleeve. In this case, it may be provided that the valve element comprises a sealing seat for sealing abutment with the control sleeve. In this connection, a development of the invention provides that the working chamber is connected to a pressure source when the valve element is held in a stationary position by the check sleeve while the control sleeve is lifted off the sealing seat. In this form of construction, it is accordingly provided that the valve element on account of its spring bias endeavours to move into sealing abutment with the control sleeve, in which case the working chamber is cut off from the pressure source. Depending on the position of the check sleeve, however, the valve element is prevented from moving into abutment with the control sleeve. Thus, it happens that in dependence upon the position of the check sleeve the control sleeve lifts off the sealing seat of the valve element, with the result that a pressure difference builds up at the movable wall and, initiated thereby, a brake force may be generated.

With regard to the regenerative braking already described in detail above, it may be provided that the check sleeve is displaceable into a position, in which no interaction with the valve element is provided. If the check sleeve is displaced into such a position, the valve element on account of its spring bias then follows every pedal-actuation-induced movement of the control sleeve, wherein control sleeve and valve element are incapable of displacement relative to one another and remain in sealing abutment in the region of the valve seat. It is thereby guaranteed that during regenerative braking, even in the event of intensive pedal actuation, a pressure build-up at the movable wall is initially prevented. It is only if the deceleration effect of the electric motor acting as a generator is no longer sufficient to meet the deceleration request of the driver expressed by the pedal actuation or to meet deceleration requirements from elsewhere (for example from drive assist systems or emergency brake assist devices) that the conventional brake system is brought additionally into operation. The check sleeve is then displaced in the opposite direction so that it keeps the valve element stationary or even moves it away from the control sleeve. Consequently, the working chamber is fluidically connected to the pressure source and the result is a pressure build-up in the working chamber that leads to generation of a brake force.

A development of the invention provides that for an emergency braking operation the force input element may be connectable to the movable wall or/and to the primary piston. Thus, if for example a failure of the vehicle electronic system means that proper control of the check sleeve is no longer possible, or if the pressure build-up at the movable wall no longer functions, then a purely mechanical braking operation without substantial deceleration is possible. The pedal actuating force exerted on the brake pedal is used directly for the pressure build-up via the primary piston in the master cylinder.

As already described above, in the case of the invention a normal braking operation, in which the brake pedal is actuated and the brake force generator is working properly, is effected in such a way that the pedal actuating force is not transmitted directly to the primary piston in the master cylinder. Instead, in such a normal braking situation the pedal actuating force dissipates. For conveying the conventional braking sensation to the driver a pedal-counterforce simulation device is provided, which is connectable mechanically or hydraulically to the force input element.

The invention further relates to a vehicle brake system having a brake force generator of the previously described type.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a brake system with a brake force generator according to the invention in normal position;

FIG. 2 is the arrangement according to FIG. 1 with the brake force generator in stand-by position;

FIG. 3 is the arrangement according to the invention with the brake force generator in a force build-up phase that has been initiated by a mechanical actuation of the force input element;

FIG. 4 is the arrangement according to the invention with the brake force generator in a force build-up phase that has been initiated by an electromagnetic actuation and displacement of the check sleeve;

FIG. 5 is the arrangement according to the invention in a position that is used for regenerative braking and

FIG. 6 is the arrangement according to the invention with the brake force generator during an accident-related emergency operation.

### DETAILED DESCRIPTION OF THE INVENTION

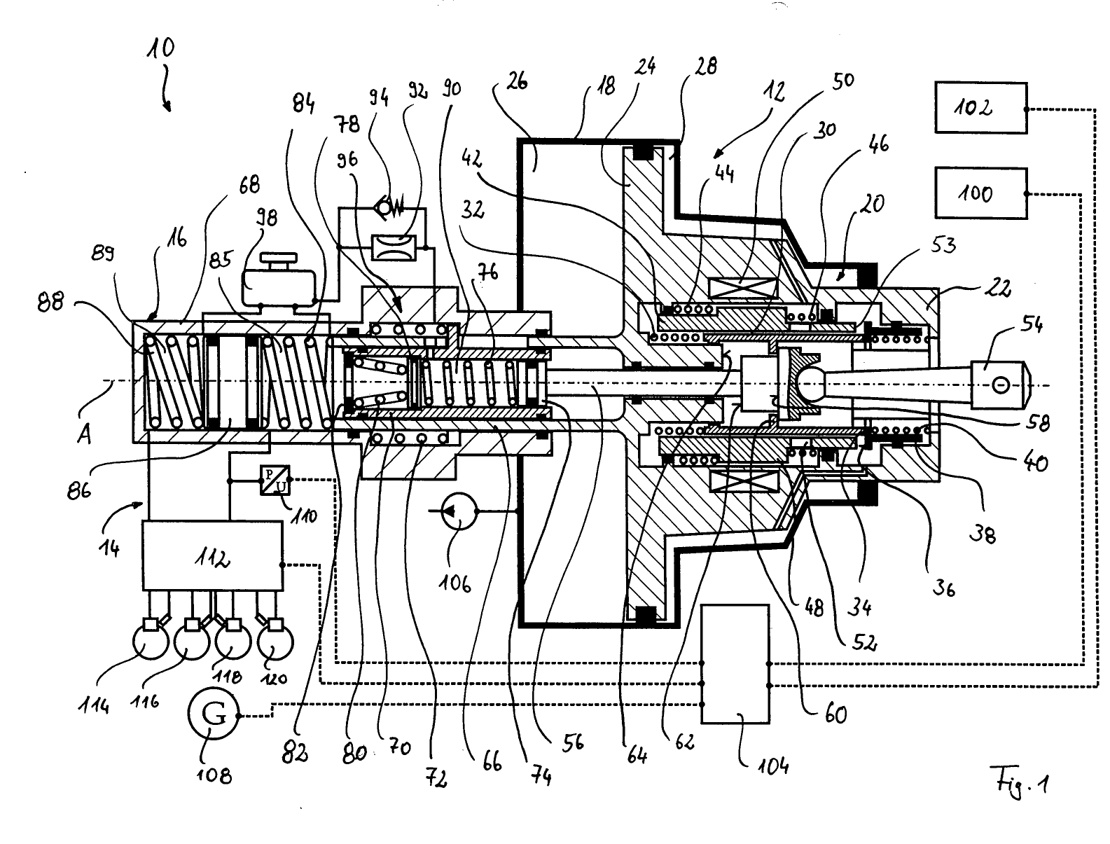

In FIG. 1 a vehicle brake system according to the invention is shown in a diagrammatic general view and generally denoted by 10. It comprises a brake force generator 12 according to the invention and a hydraulic brake circuit 14 with a wheel slip control device.

The brake force generator 12 comprises a master cylinder arrangement 16, which is connected to a booster housing 18. In the booster housing 18 a control valve 20 with a control valve housing 22 is provided. The control valve housing 22 is connected in a fixed manner to a movable wall 24. The movable wall 24 is guided sealingly in the booster housing 18 and in a fluid-tight manner separates a vacuum chamber 26 connected to a vacuum source 106 from a working chamber 28. The working chamber 28 is connectable selectively to the vacuum chamber 26 or to a non-illustrated pressure source, for example to the ambient atmosphere.

For the selective connection or separation of vacuum chamber 26 and working chamber 28 the control valve 20 is used. In the control valve housing 22, which extends along a longitudinal axis A, a control sleeve 30 is displaceably accommodated. The control sleeve 30 is biased in FIG. 1 to the right along the axial direction A by means of a compression spring 32. The control sleeve 30 at its—in FIG. 1—right end forms an annular sealing face 34. This sealing face 34 in the position shown in FIG. 1 is in sealing abutment with a sealing seat 36 of a valve element 38, which is biased in FIG. 1 to the left along the axial direction A by means of a compression spring 40. In the normal position shown in FIG. 1, the spring forces of the spring 32 and the spring 40 counterbalance one another, so that the sealing face 34 is in sealing abutment with the sealing seat 36. In this state, the working chamber 28 is fluidically separated from the pressure source.

The control sleeve 30 is surrounded in radial direction by a check sleeve 42. The check sleeve 42 is likewise guided displaceably in the control valve housing 22. It is float-mounted in the control valve housing 22 by means of two compression springs 44 and 46 acting in opposite directions, wherein the two compression springs 44 and 46 counterbalance one another in the position shown in FIG. 1. The check sleeve 42 at a middle region 48 is designed like a magnet armature. This region 48 interacts with an electrical coil 50, which is fitted on the control valve housing 22 and may, where necessary, be energized. As is further evident from FIG. 1, the check sleeve 42 is provided with radial through-holes 52. On its left end region the check sleeve 42 is also provided with an annular sealing face 53, which may likewise come into interaction with the sealing seat 36 of the valve element in order to separate the working chamber 28 fluidically from the vacuum chamber 26. In the position of the check sleeve 42 shown in FIG. 1, working chamber 28 and vacuum chamber 26 are fluidically connected to one another.

Provided in the centre of the control valve housing 22, at the righthand side, is a force input element 54, which is connectable in a non-illustrated manner by an eye to a brake pedal. The force input element 54 is accommodated by its spherical left end in a corresponding receiver of an actuating piston 56. The actuating piston 56 at its end facing the force input element is provided with a stop shoulder 58, which is in mechanical abutment with a corresponding collar 60. This end region moreover has a further stop shoulder 62, which in the normal position shown in FIG. 1 is situated at a distance from an end face 64 of the control valve housing 22.

The righthand end region of the control valve housing 22 is of a substantially hollow-cylindrical design and its end face serves as pressure piston 66. This pressure piston 66 acting as primary piston is guided in a sealingly displaceable manner in a housing 68 of the master cylinder arrangement 16. A simulator sleeve 70 is accommodated inside, and displaceable relative to, the pressure piston 66. The simulator sleeve 70 is biased into the position shown in FIG. 1 relative to the housing 68 by means of a compression spring 72.

Sealingly guided inside the simulator sleeve 70 is a simulator piston 74 that is formed on the end of the actuating piston 56. The simulator piston 74 is biased into the position shown in FIG. 1 by means of a compression spring 76. The compression spring 76 is supported by means of a dividing piston 78, which is in turn supported by a further compression spring 80 and a locking ring 82 against the simulator sleeve 70. The pressure piston 66 is biased in FIG. 1 to the right by means of the compression spring 84, wherein the compression spring 84 is supported against a secondary piston 86, which is in turn supported by a further compression spring 88 against the housing 68. The secondary piston 86 separates a primary pressure chamber 85 from a secondary pressure chamber 89, which in a conventional manner are associated with two mutually independent hydraulic brake circuits.

Enclosed within the simulator sleeve 70 is a simulation chamber 90, which together with a throttle 92 and a non-return valve 94 as well as with the compression spring 76 acting as a simulation spring forms a pedal simulation device 96. The simulation chamber 90 communicates via the throttle 92 and the non-return valve 94 with a fluid reservoir 98.

The brake system 10 according to the invention further provides a driver braking request detection device 100, as well as a brake light switch 102. An electronic control unit is denoted by 104.

The reference character 106 denotes the vacuum source already mentioned above, which is permanently connected to the vacuum chamber 26.

108 denotes an electric motor that may be used as a generator and forms part of a hybrid drive of the vehicle equipped with the brake system 10 according to the invention.

The brake circuit 14, which is monitored by a pressure sensor 110, comprises a wheel slip control device 112 that is connected fluidically as well as electronically to individual wheel brake units 114 to 120.

There now follows a detailed description of the mode of operation of the brake system 10 according to the invention having the brake force generator 12 according to the invention with reference to FIGS. 1 to 6.

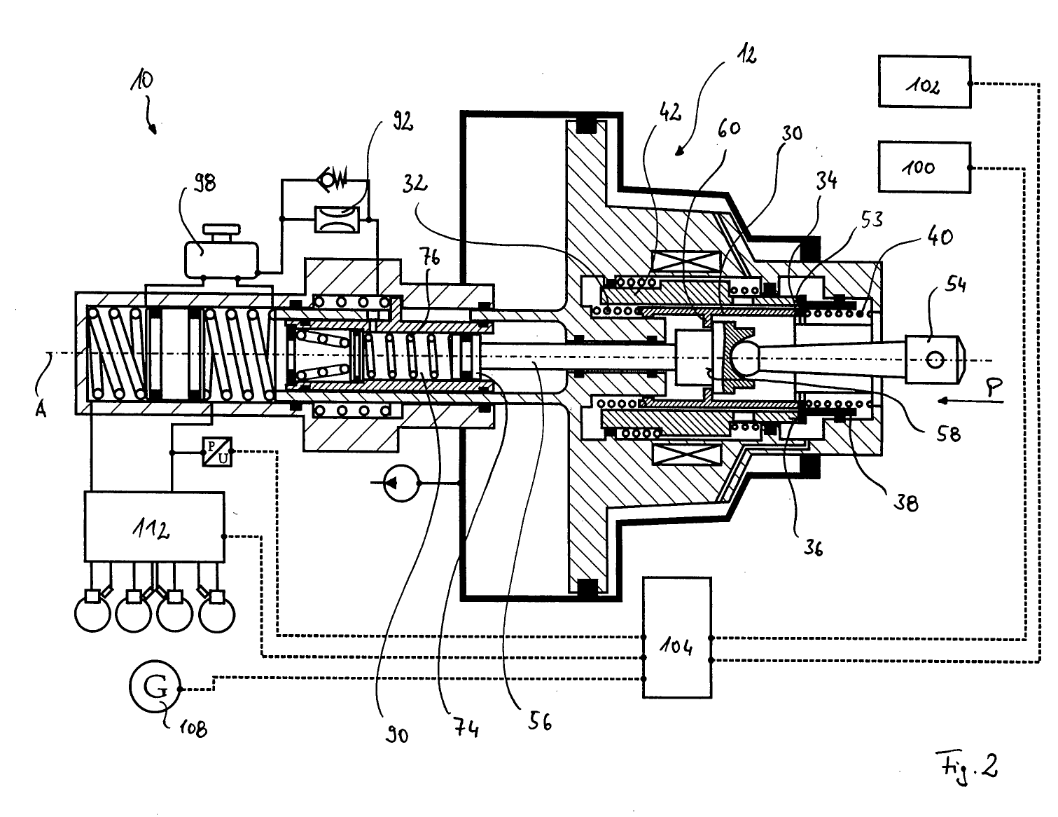

Starting from the normal position previously described with reference to FIG. 1, for example the brake pedal is actuated. With this, the force input element is displaced in the direction of the arrow P according to FIG. 2 in axial direction A to the left. The stop shoulder 58, which acts on the collar 60, ensures that the control sleeve 30 is carried along, the spring 32 in this case being compressed. The spring 40 is consequently able to relax and holds the valve element 38 with its sealing seat 36 in abutment with the sealing face 34 of the control sleeve 30. Finally, however, the sealing seat 36 also comes into abutment with the end face 53 of the check sleeve 42 facing it, so that the working chamber 28 is fluidically separated from the vacuum chamber 26. A further movement of the valve element 38 is prevented by the check sleeve 42. The system is then situated in a stand-by position. From this stand-by position, the brake system may be mechanically or electromagnetically activated.

The driver, as a result of his actuation of the brake pedal and the ensuing displacement of the force input element that leads also to a displacement of the actuating piston 56, senses a resistance that is very familiar to him. This resistance results from a compression of the simulation spring 76, as well as from the fact that displacement of the simulator piston 74 reduces the size of the simulation chamber 90, with the result that hydraulic fluid is pressed out of the simulation chamber 90 through the throttle 92 and into the fluid reservoir 98. The flow resistance of the throttle 92 and the force needed to compress the simulation spring 76 provide the very familiar pedal sensation.

Starting from the stand-by position according to FIG. 2, the system may then be further activated both mechanically by continuation of the pedal actuation and electro-magnetically in order to generate a brake force.

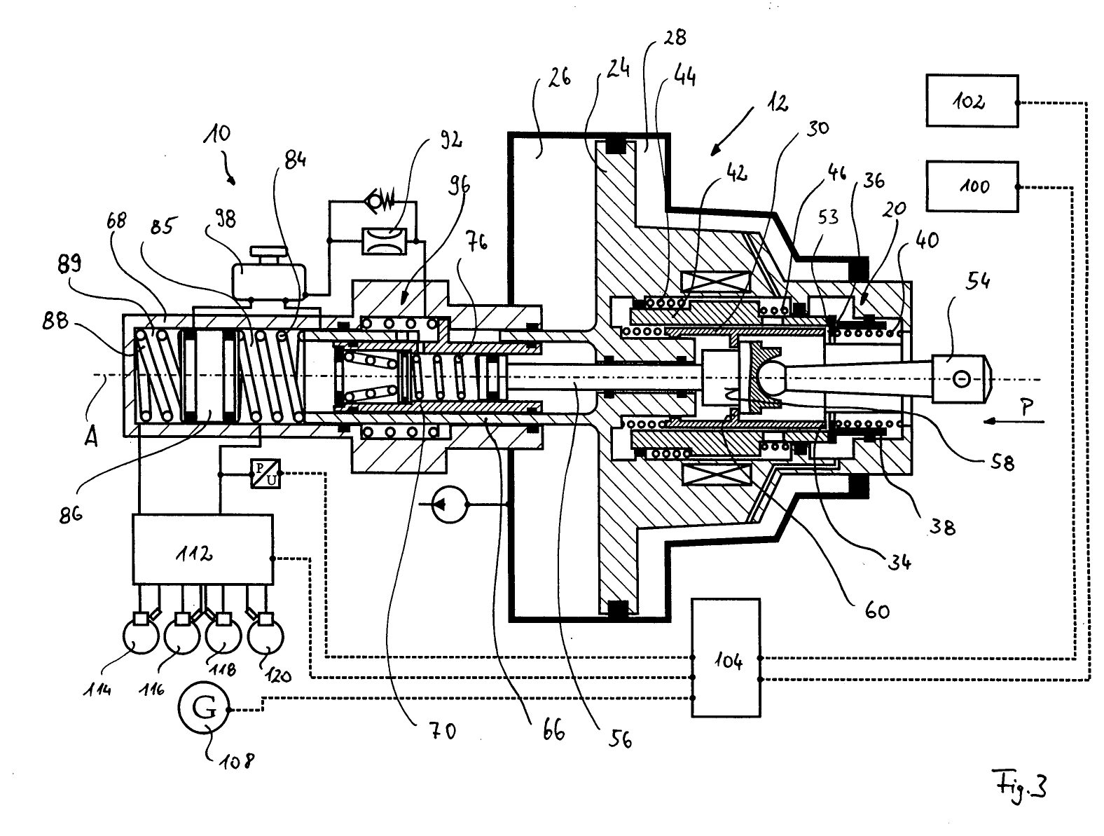

FIG. 3 shows how the system, starting from the stand-by position according to FIG. 2, performs as a result of a mechanical actuation (brake pedal actuation). In this case, the force input element is displaced according to arrow P further to the left along the longitudinal axis A. The actuating piston 56 is also displaced further into the simulator sleeve 70, the simulator spring 76 in this case being compressed to a greater extent in the previously described manner. As already mentioned, the check sleeve 42 remains substantially stationary at the location shown in FIGS. 2 and 3. This is achieved by the relatively strongly dimensioned compression spring 44, which withstands the counterforces of the springs 46 and 40. The valve element 38 is accordingly held in place by the check sleeve 42 and remains in sealing abutment with the sealing face 53 thereof, so that working chamber 28 and vacuum chamber 26 are fluidically separated from one another.

Because of the displacement of the force input element 54, however, the control sleeve 30 is carried further along by means of the stop shoulder 58 and the collar 60. The sealing face 34 of the control sleeve 30 lifts off the sealing seat 36 of the valve element 38. The result is a pressure build-up in the working chamber 28, thereby producing an overpressure at the movable wall 24. As a result of the overpressure the movable wall is displaced in FIG. 3 axially to the left, so that the pressure piston 66 engages into the housing 68 and hence brings about a pressure build-up in the primary pressure chamber 85 that accommodates the compression spring 84. The secondary piston 86 is equally displaced, thereby leading to a pressure build-up in the secondary pressure chamber 89 that accommodates the compression spring 88.

The hydraulic pressure that has built up in the primary pressure chamber 85 and the secondary pressure chamber 89 is transmitted in a conventional manner to the wheel brake units 114, 116, 118, 120. Thus, given a purely mechanical actuation via the brake pedal, the system 10 functions in such a way that the brake pedal is namely uncoupled from the actual pressure build-up because the actuating force exerted on the brake pedal dissipates in the pedal-counterforce simulation device 96. The actuation of the brake pedal however leads to a corresponding opening of the control valve 20 and to a corresponding displacement of the movable wall 24 and finally to a corresponding pressure build-up in the primary chamber 85 and the secondary chamber 89.

It is self-evident to the person skilled in the art that with the advance of the movable wall 24 as a result of the pressure build-up the check sleeve 42 is also correspondingly advanced and hence allows the valve element 38 to advance until it finally comes with its sealing seat 36 into abutment with the sealing face 34 of the control sleeve 30. The result then is therefore a state of equilibrium, in which the pressure difference at the movable wall 24 and the resultant forces counterbalance the counterforces that result from the pressure build-up in the primary chamber 85 and the secondary chamber 89. So long as the brake pedal is held in this position, the system is quasi-stationary. Each further brake pedal displacement gives rise to a fresh opening of the control valve 20 or to a pressure reduction at the movable wall 24, namely when the brake pedal is released.

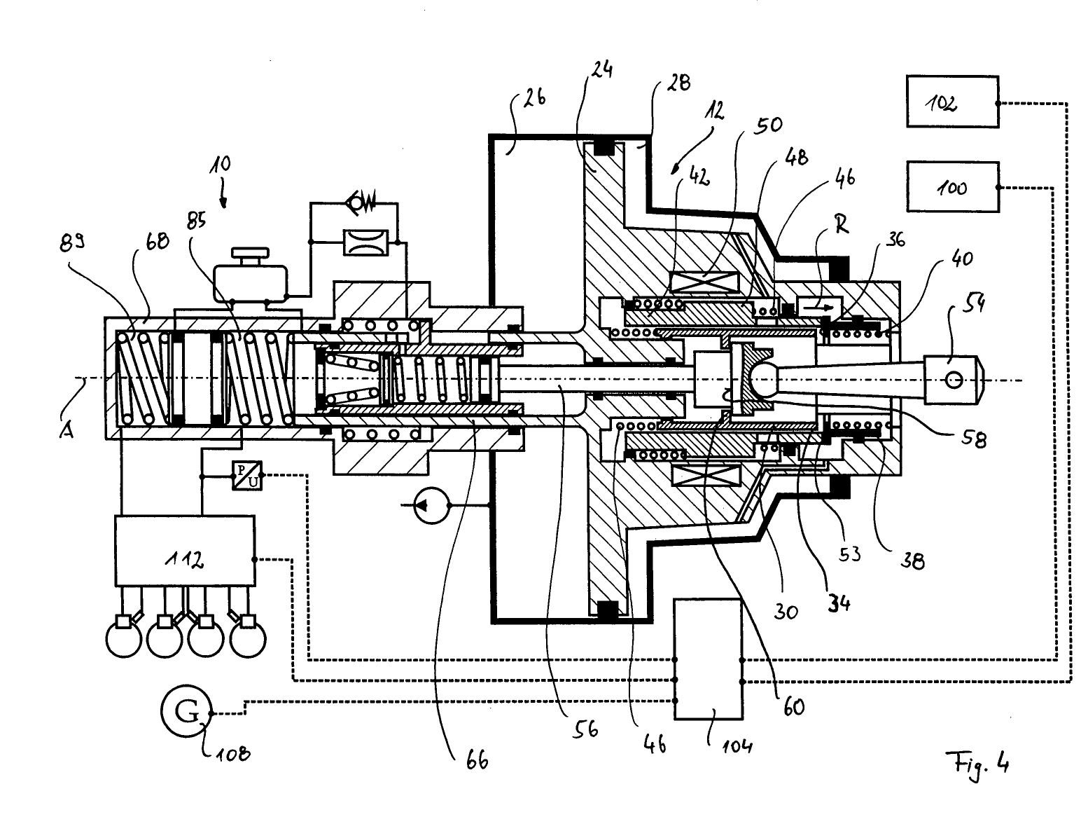

Starting from the stand-by position according to FIG. 2, the system may however also be activated electro-magnetically, as is described below with reference to FIG. 4. For example, the brake pedal remains unactuated by the driver, so that the force input element 54 also remains in its axial position. A drive assist system, such as for example adaptive cruise control or the like however detects that it is necessary to decelerate the vehicle, even though the driver has not actuated the brake pedal. Consequently, the coil 50 is energized in such a way that the check sleeve 42 is moved in FIG. 4 according to arrow R to the right. This is effected by an, as such, known interaction between the coil 50 and the magnet armature region 48 of the check sleeve 42. Because of this movement, the valve element 38 is displaced counter to the action of the spring 40 in a corresponding manner to the right. The sealing seat 36 of the valve element 38 is therefore lifted off the sealing face 34 of the control sleeve 30, the sealing face 53 of the check sleeve 42 remaining in sealing abutment with the valve element 38. The control sleeve 30 is unable to follow the movement of the valve element 38 because it is held in place by the collar 60 and the stop shoulder 58.

Once again, the separation of the sealing face 34 and the sealing seat 36 leads to a pressure build-up inside the working chamber 28, so that the movable wall 24 is displaced in FIG. 4 axially to the left. The pressure piston 66 engages into the housing 68 and gives rise to a pressure build-up in the pressure chambers 85 and 89. As a result of the displacement of the movable wall 24, the check sleeve 42 is simultaneously moved in a correspondingly manner, thereby leading once again to the state of equilibrium already described above, so long as the energization of the coil 50 is not altered.

From FIG. 4 it is clear that the system may also be activated purely electromagnetically, independently of the driver, in order to allow an autonomous braking operation with no driver intervention. In order to cancel this braking state in a corresponding manner, the energization of the coil 50 is reduced to zero. The two springs 44 and 46 ensure that the check sleeve 42 returns to its normal state, so that the stand-by position according to FIG. 2 is adopted.

An actuation according to FIG. 4 may also be brought about in an emergency braking situation in order to assist the driver during the braking operation so that he has the maximum brake force available to him as quickly as possible and for a sufficient length of time. By means of the check sleeve the sealing seat 36 may therefore be lifted off the sealing face 34 abruptly and for a long period of time.

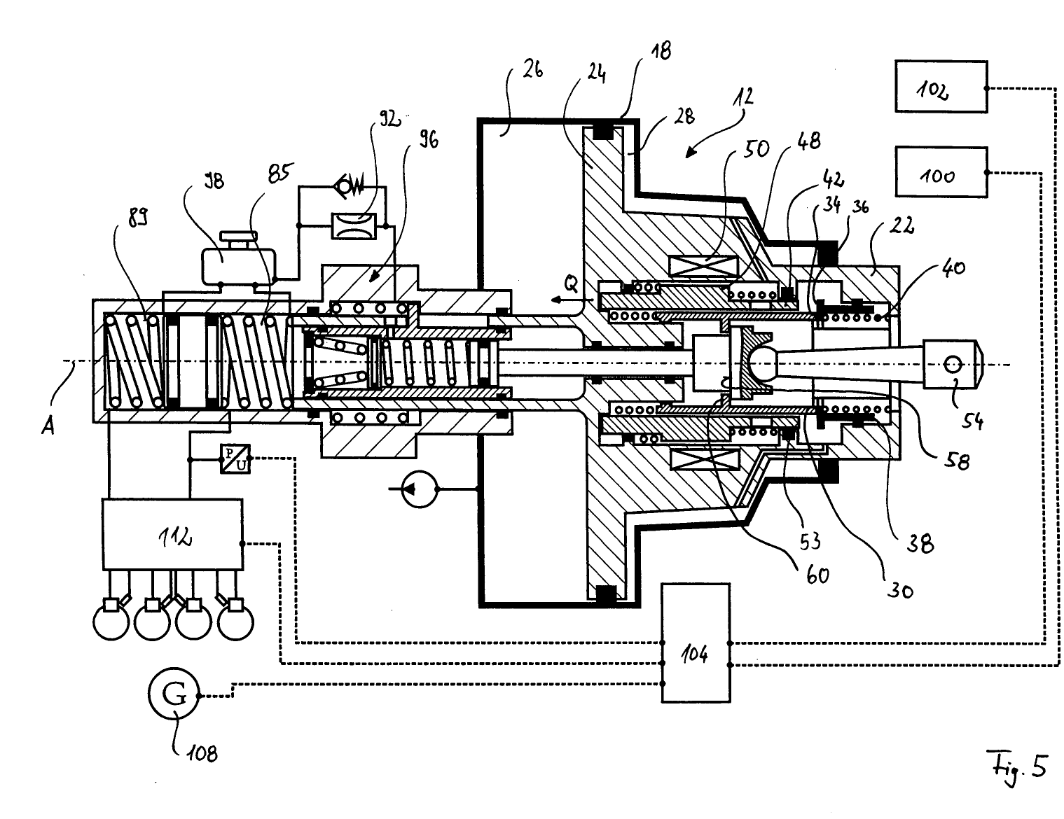

FIG. 5 shows a state that is adopted by the system when in a hybrid vehicle the deceleration effect of the generator 108 is to be utilized efficiently. Thus, for example the driver braking request detection device 100 detects the braking request of a driver or by means of the already previously mentioned drive assist system it is established that it is necessary to decelerate the vehicle. In a first phase of such a deceleration, the deceleration effect of the electric motor 108 acting as a generator is often sufficient to achieve adequate deceleration of the vehicle. In order in this case to prevent a pressure build-up at the movable wall 24 as a result of the brake pedal actuation, the coil 50 is energized in such a way that it displaces the check sleeve 42 by means of the magnet armature region 48 according to arrow Q, preferably as far as possible, in FIG. 5 axially to the left. From FIG. 5 it is evident that the check sleeve 42 has been displaced according to arrow Q so far to the left that its end face is in abutment with a corresponding stop face of the control valve housing 22. The sealing face 53 is lifted far off the sealing seat 36, with the result that the working chamber 28 is fluidically connected to the vacuum chamber 26.

In this state, despite a displacement of the force input element 54 and a resulting displacement of the control sleeve 30 as a result of the control sleeve 30 being carried along by means of the stop shoulder 58 and the collar 60, a separation of the sealing face 34 from the sealing seat 36 does not occur. Rather, the compression spring 40 ensures that the valve element 38 follows every movement of the control sleeve 30 and is simultaneously moved in such a way that the sealing face 34 remains in sealing abutment with the sealing seat 36. A further result of this is however that, given such a positioning of the check sleeve 42, the sealing seat 36 of the valve element 38 cannot be supported against the check sleeve 42 and so a separation between sealing seat 36 and sealing face 34 cannot occur either. A pressure build-up in the working chamber 28 is therefore prevented.

The brake force generator 12 therefore remains inactive and it is possible to utilize the braking effect of the generator 108 to the full extent. However, should the braking effect needed for the desired deceleration exceed the maximum deceleration effect of the generator 108, the energization of the coil 50 is changed in such a way that the check sleeve 42 is displaced from the position shown in FIG. 5 to the right until it comes into abutment with the valve element 38. Working chamber 28 and vacuum chamber 26 are therefore fluidically separated from one another.

A further displacement of the check sleeve 42 to the right would then bring about a separation of the sealing face 34 from the sealing seat 36 and lead to the build-up of a pressure difference at the movable wall 24, so that in the primary pressure chamber 85 and in the secondary pressure chamber 89 a pressure build-up occurs. The coming of the check sleeve 42 into abutment with the valve element 38 and the consequent separation of sealing face 34 and sealing seat 36 occur continuously and steplessly, so that in a gentle and pressure-free manner the braking effect of the brake force generator 12 may come into operation in addition to the braking effect of the generator 108. The driver is not aware of this at all and has the impression that the deceleration resulting as a whole from the generator braking effect and the brake force generator braking effect is built up continuously.

It should be mentioned that the pedal-counterforce simulation device 96, given the positioning of the check sleeve 42 shown in FIG. 5, constantly and in the previously described manner conveys a very familiar pedal sensation to the driver.

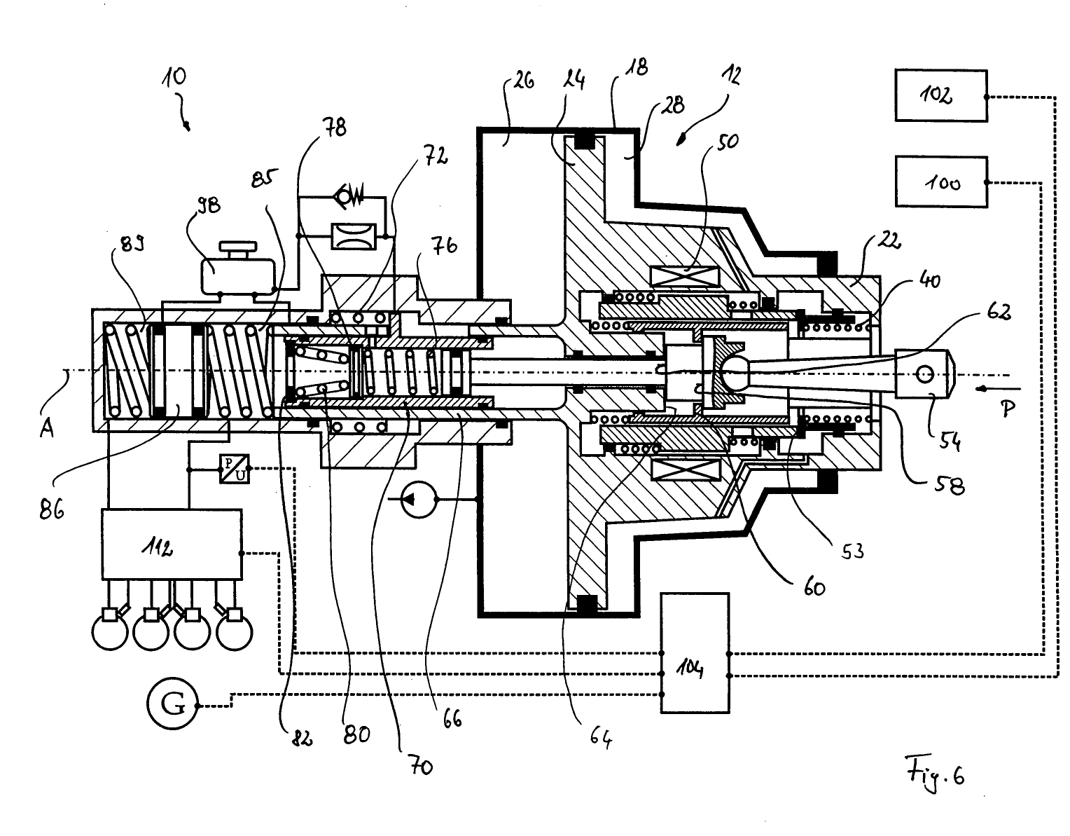

FIG. 6 then shows a situation, in which the brake force generator 12 has failed, for example because owing to a leak in the working chamber 28 a pressure build-up is no longer possible or because of an electronic defect. In the event of a brake pedal actuation, the force input element 54 is displaced in axial direction. The stop shoulder 62 finally comes into abutment with the end face 64 of the control valve housing 22 facing it. A further movement along the arrow P brings about a displacement of the pressure piston 66. This leads to a pressure build-up in the primary pressure chamber 85 and, through displacement of the secondary piston 86, in the secondary pressure chamber 89. Once the simulator spring 76 has been compressed to a specific extent, the spring 72 is compressed. This leads to a displacement of simulator sleeve 70 and dividing piston 78 with the pressure piston 66, so that the entire unit may be utilized to build up pressure in the primary pressure chamber 85 and in the secondary pressure chamber 89.

The brake system 10 according to the invention with the brake force generator 12 according to the invention therefore offers a simple structural design together with all possibilities of actuation in a mechanical or electromagnetic manner and of utilization in a system with regenerative braking. The system according to the invention moreover offers a fallback situation for the eventuality that the pneumatic or/and electrical equipment of the brake force generator 12 fails, with the result that a purely mechanical braking operation is also possible.

In accordance with the provisions of the patent statutes, the principle and mode of operation of its invention has been explained and illustrated in its preferred embodiment. However, it must be understood that this invention may be practiced otherwise than as specifically explained and illustrated without departing from its spirit or scope.

What is claimed is:

1. Brake force generator for a vehicle hydraulic brake system comprising:
a force input element that is connectable or connected to a brake pedal,
a master cylinder, in which a primary piston is displaceably guided, wherein the primary piston with the master cylinder delimits a primary pressure chamber for generating a hydraulic brake pressure, and
an actuating-force generating device for exerting an actuating force on the primary piston,
wherein the actuating-force generating device comprises a control valve and a chamber arrangement, wherein the chamber arrangement is formed by a vacuum chamber and a working chamber, which is separated from the vacuum chamber by a movable wall and fluidically connectable by the control valve, and wherein the control valve comprises a control sleeve, which is displaceable relative to a valve element in accordance with a pedal actuation to achieve a pressure difference between the working chamber and the vacuum chamber that determines the actuating force, wherein there is associated with the control valve a check sleeve, which is displaceable in accordance with specific operating conditions and the position of which may be used to influence the relative movement between control sleeve and valve element.

2. Brake force generator according to claim 1,
wherein the check sleeve is displaceable electromagnetically.

3. Brake force generator according to claim 2,
wherein the check sleeve takes the form of an electromagnetic armature.

4. Brake force generator according to claim 1,
wherein the check sleeve is biased into a normal position by means of a spring arrangement and is displaceable in mutually opposite directions with simultaneous deflection of the spring arrangement.

5. Brake force generator according to claim 1,
wherein the check sleeve surrounds the control sleeve in radial direction.

6. Brake force generator according to claim 1,
wherein the control sleeve is connectable or connected mechanically to the force input element.

7. Brake force generator according to claim 1,
wherein the valve element is spring-biased in the direction of, and bringable into mutual abutment with, the control sleeve and the check sleeve.

8. Brake force generator according to claim 1,
wherein the valve element comprises a sealing seat for sealing abutment with the control sleeve.

9. Brake force generator according to claim 8,
wherein the working chamber is connected to a pressure source if the valve element is held in a stationary position by the check sleeve while the control sleeve is lifted off the sealing seat.

10. Brake force generator according to claim 1,
wherein the check sleeve for a regenerative braking operation is displaceable into a position, in which no interaction with the valve element is provided.

11. Brake force generator according to claim 1,
wherein for an emergency braking operation the force input element is mechanically connectable to one of the movable wall and the primary piston.

12. Brake force generator according to claim 1,
including a pedal-counterforce simulation device that is one of mechanically and hydraulically connectable to the force input element.

13. Vehicle brake system having a brake force generator according to claim 1.

14. Brake force generator according to claim 1,
wherein for an emergency braking operation the force input element is mechanically connectable to the movable wall and to the primary piston.
